(19) United States
(12) Patent Application Publication
(10) Pub. No.: US 2011/0308135 A1
(43) Pub. Date: Dec. 22, 2011

(54) Spinner bait

(76) Inventor: Robert Uhrig, Jackson, NJ (US)

(21) Appl. No.: 13/134,768

(22) Filed: Jun. 16, 2011

Related U.S. Application Data
(60) Provisional application No. 61/397,888, filed on Jun. 17, 2010.

(51) Int. Cl. A01K 85/10; A01K 97/06

(52) U.S. Cl. 43/42.19; 43/54.1

(57) ABSTRACT

The spinning bait includes a keeper having a fish-shaped front part and a rear part articulated to the front part for side to side movement relative thereto. When in use, after being cast into a body of water, pulling on a fishing line attached to the front part of the keeper causes the rear keeper part to move to and fro in a side-to-side manner relative to the front keeper part and fishing line to attract a fish. A hook is mounted on the rear part along with a skirt with buoyant trailers that extending beyond the hook. One or more spinning blades are mounted on a wire extending from the front part of the keeper.

This is a Non-Provisional Patent Application and claims the benefit of Provisional Patent Application 61/397,888, filed Jun. 17, 2010.

This invention relates to a spinner bait. More particularly, this invention relates to a spinner bait for fish.

As is known, various types of fishing jigs and lures have been used to catch fish, particularly, bass. For example, as described in U.S. Pat. No. 4,596,086, fishing jigs have been provided with a hook and a flexible plastic skirt having tails which are intended to jiggle in the water as the fishing jig passes through the water. In addition, such fishing jigs have been provided with a weed guard in the form of a soft plastic elongated member into which the fishing hook can be embedded in order to avoid snagging of the hook on weeds, branches or other submerged debris. However, when the fishing jig is bitten by a fish, a barbed tip on the hook is to pass through the weed guard into the fish.

Typically, when fishing for predatory fish, such as bass, the fishing jigs are caused to sink to the bottom of the stream or other body of water to lie in wait for a bass to become attracted to the jig. In some cases, the jigs are moved so that the tails of a plastic skirt secured to the jig create movement to further attract the fish. However, based upon experience, it appears that bass are wary of fishing jigs that have hooks and weed guard that are exposed to view. In such cases, the bass tend to avoid such jigs.

Accordingly, it is an object of the invention to provide a spinner bait that is attractive for fish, particularly, bass.

It is another object of the invention to provide a spinner bait that simulates the movement of a fish so as to attract a predatory fish.

Briefly, the invention provides a spinner bait that includes a keeper having a fish-shaped front part and a rear part articulated to the front part for side to side movement relative thereto. When in use, after being cast into a body of water, pulling on a fishing line attached to the front part of the keeper causes the rear keeper part to move to and fro in a side-to-side manner relative to the front keeper part and fishing line to attract a fish.

The keeper includes a hinge hinging the front part and rear part together. For example, the hinge includes a pin secured in a rear of the front part and an eyelet secured in the rear part.

The spinner bait also includes a hook extending from one end of the keeper and a wire extending from an opposite end of the keeper from the hook.

The keeper is constructed to allow a skirt having an elastic band for mounting to be seated in an annular recess in the rear part and a plurality of buoyant trailers to extend from said band and beyond the hook.

The wire is constructed to receive one of more spinner blades and to receive a fishing line.

These and other objects and advantages of the invention will become more apparent from the following detailed description taken in conjunction with the accompany drawings wherein:

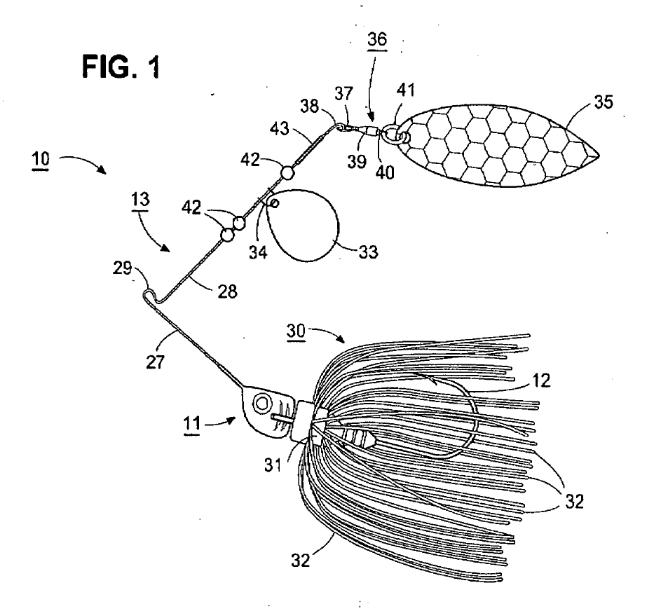

FIG. 1 illustrates a view of a spinner bait constructed in accordance with the invention;

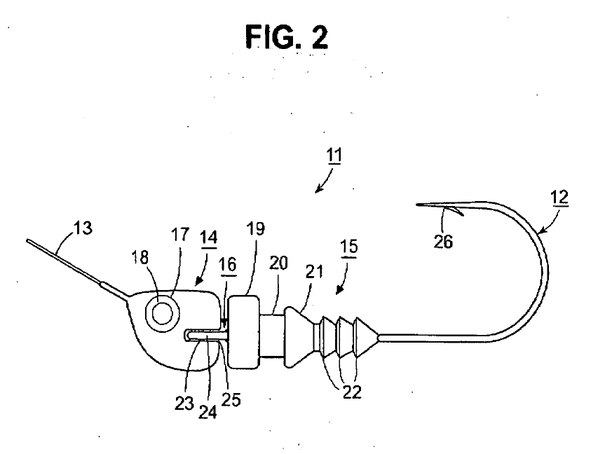

FIG. 2 illustrates a side view of a hook and keeper of the spinner bait of FIG. 1; and

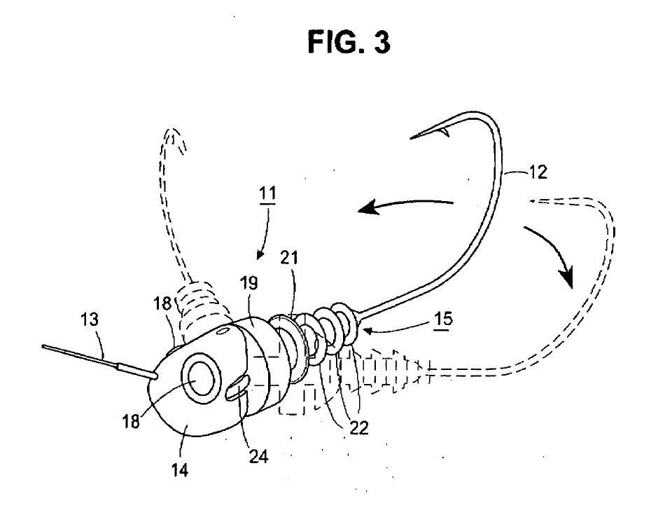

FIG. 3 illustrates a perspective articulated view of the keeper and hook of FIG. 2.

Referring to FIG. 1, the spinner bait 10 is constructed of a keeper 11, a hook 12 extending from one end of the keeper 11 and a wire 13 extending from an opposite end of the keeper 11 from the hook 12.

Referring to FIGS. 2 and 3, the keeper 11 is formed of two parts 14, 15 that are articulated to each other via a hinge 16. One keeper part 14 is in the shape of a fish head and forms the front of the keeper 11. This keeper part 14 is made of lead and is integrally formed with one end of the wire 13. As illustrated, each side of the keeper part 14 is provided with a recess 17 to receive a simulated fish eye 18, for example of plastic.

The other keeper part 15 forms the rear of the keeper 11 and is also made of lead. This part 15 includes a collar 19 at the forward end, an annular recess 20, a tapered shoulder 21 and a series of spaced apart rings 22, each of which has a conical surface on one side and a re-entrant surface on the opposite side. This keeper part 15 is integrally formed with one end of the hook 12.

The hinge 16 is formed of a pin 23 that is secured in the rear of the forward keeper part 14 and an eyelet 24 that is secured in the forward part of the rear keeper part 15. The eyelet 24 projects from the rear keeper part 15 into a slot 25 in the back of the forward keeper part 14 and the pin 23 passes through the eye (not shown) of the eyelet 24 within the slot 25.

The hinge 16 allows the rear keeper part 15 to pivot from side to side relative to the front keeper part 14 as indicated in phantom in FIG. 3 to simulate the movement of a fish. For example, the rear keeper part 15 may pivot up to 90° relative to each side of the forward keeper part 14 to cover an arc of 180°.

The hook 12 is made of a conventional material, such as steel, and of conventional shape, such as, being reversibly bent on itself with a barb 26 at the end.

The wire 13 is made of a conventional material, such as steel, and is of L-shape with a pair of legs 27, 28 separated by a loop section 29. One leg 27 is secured in the keeper part 14 and extends therefrom in a straight rectilinear manner to the loop section 29. The second leg 28 extends from the loop section 29 in a cantilevered manner at a 90° angle relative to the first leg 27. The loop section 29 is bent on itself and provides a spring-like effect that allows the second leg 28 to flex back and forth relative to the first leg 27 under a load.

Referring to FIG. 1, the spinner bait 10 is provided with a skirt 30 that is disposed about the rear keeper part 15. This skirt 30 has an elastic band 31 that is seated in the annular recess 20 between the collar 19 and shoulder 21. In addition, the skirt 30 includes a plurality of buoyant trailers 32 that extend from the band 31 and that are of a length to extend beyond the hook 12 so as to conceal the hook 12 during use. The trailers 32 are in the form of filaments that extend from both sides of the elastic band 31 and are of any suitable material, such as silicone, rubber, plastic, hair, feathers and the like. In addition, the trailers 32 may be made of any suitable color.

The spinner bait 10 is also provided with one or more spinner blades on the outstanding leg 28. For example, as shown, the outstanding leg 28 of the wire 13 has a relatively small tear-drop shaped blade 33 mounted intermediately thereon via a wire loop 34 that allows the blade 33 to hang freely from the wire leg 28 and to be rotated 360° about the wire leg 28. The wire loop 34 is slidably mounted on the wire leg 28 to allow the blade 33 to move longitudinally along the wire leg 28.

The outstanding leg 28 also has a relatively large oval-shaped blade 35 mounted at the end of the leg 28 via a swivel joint 36 that allows the blade 35 to hang freely from the leg 28 and to be rotated 360° about the longitudinal axis of the blade 35. As shown, the swivel joint 36 has a first ring 37 disposed on a looped end 38 of the leg 28, a housing 39 secured via a bore to the first ring 37, a clevis pin 40 extending from the housing 39 and rotatably mounted therein and a second ring 41 secured in a bore of the clevis pin 40 for rotation therewith. The second ring 41 is secured to the blade 35 via a bore in the blade 35.

In order to maintain the smaller blade 33 out of contact with the loop section 29, a pair of spacer elements 42 in the shape of balls, are slidably mounted on the wire leg 28 between the loop section 29 and the wire loop 34. Also, in order to maintain the blades 33, 35 out of contact, an elongated plastic sleeve 43 is fixedly secured concentrically on and about the end of the wire leg 28 and a spacer element 42 is slidably mounted on the wire leg 28 between the wire loop 34 and the sleeve 43.

When in use, a suitable fishing line (not shown) is secured to the wire 13 of the spinner bait 10, for example, at the loop section 29 between the legs 27, 28. After being cast into a body of water, the lead weighted keeper 11 causes the spinner bait to sink while pulling on the fishing line causes the rear keeper part 15 and skirt 30 to move to and fro in a side-to-side manner relative to the forward keeper part 14 and fishing line to attract a fish. At the same time, the spinner blades 33, 35 are caused to flutter and move through the water to create a further attraction for a fish.

Typically, a fish, for example, a bass, approaches a forwardly moving spinner bait not from directly behind the hook but at an angle to the rear of the bait. Upon opening of the mouth of the fish to engage the bait, an inhaling action occurs into the mouth and then a closing of the mouth. Frequently, these two actions cause the fish to miss the bait and not be caught. However, with the spinner bait 10, since the rear keeper part 15 is swinging from side to side as the spinner bait is being pulled forwardly, as a fish inhales, the hook 12 is drawn towards the mouth of the fish and upon closing of the fish's mouth, the hook 12 impales the fish. Hence, the risk of losing a fish is diminished.

Further, once a fish is hooked, any back and forth movement of the fish in an attempt to unhook itself is accommodated by the hinge 16 thereby leaving the hook 12 engaged in the fish.

What is claimed is:

1. A spinner bait comprising
a keeper having a fish-shaped front part and a rear part articulated to said front part for side to side movement relative thereto;
a hook extending from one end of said keeper; and
a wire extending from an opposite end of said keeper from said hook.

2. A spinner bait as set forth in claim 1 further comprising a hinge hinging said front part and said rear part together.

3. A spinner bait as set forth in claim 2 wherein said hinge includes a pin secured in a rear of said front part and an eyelet secured in said rear part.

4. A spinner bait as set forth in claim 3 wherein eyelet projects from said rear part and said front part has a slot receiving said eyelet with said pin received in said eyelet within said slot.

5. A spinner bait as set forth in claim 1 wherein said front part is made of lead and is integrally formed with one end of said wire.

6. A spinner bait as set forth in claim 1 further comprising a plastic simulated fish eye on each side of said front part.

7. A spinner bait as set forth in claim 1 wherein said rear part is made of lead and is integrally formed with one end of said hook.

8. A spinner bait as set forth in claim 7 wherein said rear part includes a collar at a forward end, an annular recess, a tapered shoulder and a series of spaced apart rings, each said ring having a conical surface on one side and a re-entrant surface on the opposite side.

8. A spinner bait as set forth in claim 7 further comprising a skirt having an elastic band seated in said annular recess and a plurality of buoyant trailers extending from said band and beyond said hook.

9. A spinner bait as set forth in claim 1 wherein said wire is of L-shape with a pair of legs and a loop section therebetween.

10. A spinner bait as set forth in claim 9 wherein one leg of said wire is secured in said front part 14 and extends therefrom in a straight rectilinear manner to said loop section and the other leg of said wire extends from said loop section at a 90° angle relative to said one leg.

11. A spinner bait as set forth in claim 10 wherein said loop section is bent on itself and provides a spring-like effect that allows said other leg to flex back and forth relative to said one leg under a load.

12. A spinner bait as set forth in claim 10 further comprising at least one spinner blade on said other leg.

13. A spinner bait as set forth in claim 12 further comprising a pair of spacer elements slidably mounted on said one leg between said loop section and said spinner blade.

14. A spinner bait as set forth in claim 12 further comprising a swivel joint mounted on an end of said other leg and second blade mounted said swivel joint for rotation about the longitudinal axis of said second blade.

15. A spinner bait as set forth in claim 14 further comprising a plastic sleeve fixedly secured concentrically on and about said end of said other leg and a spacer element slidably mounted on said other leg between said sleeve and said at least one spinner blade.

16. A keeper for a spinner bait comprising
a fish-shaped front part having a slot at one end and a pin transverse to said slot and passing into said slot; and
a rear part having an eyelet secured in and projecting therefrom said rear part, said eyelet receiving said pin to pivot said rear part relative to said front part for side to side movement relative thereto.

17. A keeper for a spinner bait as set forth in claim 16 further comprising a hook extending from said rear part and a wire extending from said front part.
